(19) United States
(12) Patent Application Publication
(10) Pub. No.: US 2007/0011465 A1
(43) Pub. Date: Jan. 11, 2007

(54) Methods and systems for ensuring accuracy of health-related data transmission over a network

(75) Inventors: Jeffrey James Webber, Vista, CA (US); Matthew H.L. Sanders, Los Altos Hills, CA (US); Rose Higgins, Washington Crossing, CA (US)

Correspondence Address: BEYER WEAVER & THOMAS, LLP, P.O. BOX 70250, OAKLAND, CA, 94612-0250, US

(73) Assignee: iMetrikus, Inc., Carlsbad, CA (US)

(21) Appl. No.: 11/432,746

(22) Filed: May 11, 2006

Related U.S. Application Data
(60) Provisional application No. 60/679,716, filed on May 11, 2005.

(51) Int. Cl. H04K 1/00; H04L 9/00

(52) U.S. Cl. 713/186

(57) ABSTRACT

Methods and systems are described for ensuring a high degree of accuracy in the transmission of biometric data (e.g., from a home monitoring device) over a potentially high-noise, error-introducing communication link, such as the Internet, wireless networks, and the telephone system. An intermediate biometric data transmission device is used to receive biometric data from a home monitoring device. The intermediate device encapsulates the raw data packets (which include a checksum) from the home monitoring device in an intermediate data packet with its own checksums. The intermediate device data packet is transmitted over a communication medium to a remote data repository, such as a health data management system. There, the checksums of the intermediate data packet are checked to ensure that the transmission was error free and then the checksums of the original raw biometric data packet are checked using device-specific CRC algorithms stored at the remote system. Thus, two layers of data accuracy checks are made and both are done at the “back end” system rather than at the intermediate device at the home-user end. The high data accuracy may meet standards set for health and medical data transmission over public networks by government agencies and standard-making entities.

### CROSS-REFERENCE TO RELATED APPLICATION

This applications claims priority to U.S. Provisional Application No. 60/679,716 filed May 11, 2006, entitled “Biometric Data Collection and Monitoring Network” incorporated herein by reference in its entirety.

### FIELD OF THE INVENTION

The present invention relates generally to methods and computer systems for accurately and securely transmitting health-related data over a network. More specifically, the invention relates to ensuring that data from a home biometric monitoring device are transmitted with bit-by-bit accuracy over a network to a destination data repository.

### BACKGROUND OF THE INVENTION

Home health monitoring devices, also referred to as home biometric meters, are becoming increasingly prevalent and are seen as a key component in the movement of focusing the locus of healthcare at the home and workplace rather than at hospitals and clinics. There are presently hundreds of home health monitoring devices, many are used for monitoring chronic illnesses such as diabetes, asthma, heart disease, HIV, obesity, to name just a few. Biometric readings from these devices consist of data that can be verified, calibrated and validated, and often have to transmitted from the home monitoring device to a destination storage area where they can be studied, analyzed, and archived. Increasingly, these data are transmitted from the device to a remote database using the Internet, cellular phone networks, and telephone lines (“POTS”). The nature of the data transmitted and the consequences of data not being transmitted accurately warrant that extra measures be taken to ensure bit-by-bit accuracy of data transfer.

It is also increasingly common for households to have more than one home monitoring device. This is almost certainly the case for clinics and hospitals. In the situation where there is more than one remote biometric meter, an intermediate biometric data transmission device can be adapted to transmit data from one of numerous home devices to a central repository accessible via the Internet, POTS, wireless networks, cellular phone networks, satellites, and so on. When an intermediate data transmission device is used, it is important to ensure that the data transmitted from the monitoring device to the central repository via the intermediate device are absolutely accurate, verifiable, and auditable. For these purposes it is also useful, if not necessary, to store the original biometric reading in their original format at the central repository.

Biometric data transmission accuracy and integrity can also be a government agency or standards body requirement that the intermediate device or home device may strive to meet. For example, for a device to meet Level 2 Federal Drug Administration (U.S.) standards, the data must be transmitted from the device or devices to a central repository with bit-by-bit accuracy and be transmitted in a manner where the reading can be verified and audited. Errors in transmission must be immediately detected. If there is any indication during the transmission of data that there may have been an error, the data should be discarded and the process repeated (e.g., re-send the data, take another reading, etc.) or a user should be notified to take further action.

Therefore, it would be desirable to have a system and process in which data are transmitted from a home monitoring device to a third-party database via an intermediate biometric transmission device while ensuring bit-by-bit accuracy of data transmission. It would also be desirable to be able to verify and audit the data and have a system that is immediately reactive or responsive to any data error transmissions. It would also be desirable to have the system and process meet governmental agency standards for health and medical data transmission.

### SUMMARY OF THE INVENTION

Methods and systems for enabling a high degree of accuracy of biometric data transmission from a home monitoring device to a health data management system are described. In the primary aspect of the present invention, a method of ensuring that biometric data from a monitoring device that are transmitted via an intermediate data transmission device over a network such as the Internet, POTS, or a cell phone network, are received at a remote database without being corrupted or inaccurate in any manner. The database is a component of a health data management system which stores the biometric data in its original, proprietary format and in a format specific to the management system. If it is determined that there the data arrived corrupted, messages are sent to the home monitoring device and appropriate action is taken.

In one embodiment of the present invention, the CRCs of two data packets are checked. An original biometric data packet in a proprietary format is sent from the home device to the intermediate biometric data transmission device. This packet has a checksum or CRC (Cyclic Redundancy Check) sequence of bytes. Once received at the intermediate device, the original packet is encapsulated in another data packet, which can be referred to as the intermediate device data packet. This outer data packet has its own checksum or CRC bytes. The payload of the intermediate device data packet is the entire original biometric data packet. The intermediate device data packet is transmitted over a selected network and received at the health data management system. The manner in which the intermediate device packet is received depends on the mode of transmission, e.g., Internet, POTS, cellular network, etc. At the management system, the CRC bytes of the intermediate data packet are checked first to ensure that transmission over the network was error-free. If the packet passes this test, the CRC bytes or checksums of the original data packet (the payload of the intermediate device data packet) are checked to ensure that the transmission between the home monitoring device and the intermediate device was error free. Thus, because it is not assumed that the data transmitted from the home device to the intermediate data transmission device was necessarily accurate, two layers of data checks are performed to implement a high level of transmission accuracy of biometric data in the present invention.

### BRIEF DESCRIPTION OF THE DRAWINGS

The invention will be better understood by reference to the following description taken in conjunction with the accompanying drawings in which:

FIG. 1 is a diagram of an intermediate data transmission device and a home monitoring device of the present invention;

FIG. 2 is a network diagram showing the basic components and flow of data of the present invention;

FIG. 3 is an overview flow diagram of a process of biometric data transmission in accordance with one embodiment of the present invention;

FIG. 4 is a diagram showing a sample of a biometric data packet and a sample of an intermediate device data packet in accordance with one embodiment of the present invention; and

FIG. 5 is a block diagram showing components of a health data management system in accordance with a described embodiment of the present invention.

### DETAILED DESCRIPTION OF THE PRESENT INVENTION

Reference will now be made in detail to a preferred embodiment of the present invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

Biometric home monitoring devices are becoming increasingly prevalent. More and more patients, especially those with chronic conditions, are taking readings at home or at the workplace to monitor their conditions. These biometric data readings are often transmitted to a remote location so they can be analyzed by healthcare professionals and archived. The prevalent mode of transmitting these data is using the Internet, and in most cases the data go to either a database in a proprietary format operated by the device manufacturer or to a clinic where the data cannot be easily shared. For some patients, especially elderly patients with chronic illnesses, it is difficult to access a computer, download data from a device and transmit the data over the Internet. In these cases, the telephone system or a wireless cellular phone network is used to transmit data.

To alleviate problems and issues raised with proprietary data formats, isolation of biometric data (i.e., not easily sharing or integrating with other health data of the patient), data transmission obstacles, and other drawbacks stemming from the use of home monitoring devices, an intermediate biometric data transmission device has been developed to address these issues. Such a device is disclosed in pending application Ser. No. 09/977,472 titled “Method and Apparatus for Communicating Data Between a Medical Device and a Central Data Repository” and is incorporated by reference in its entirety for all purposes. An example of such a device is MetrikLink®, available from iMetrikus, Inc. of Carlsbad, Calif.

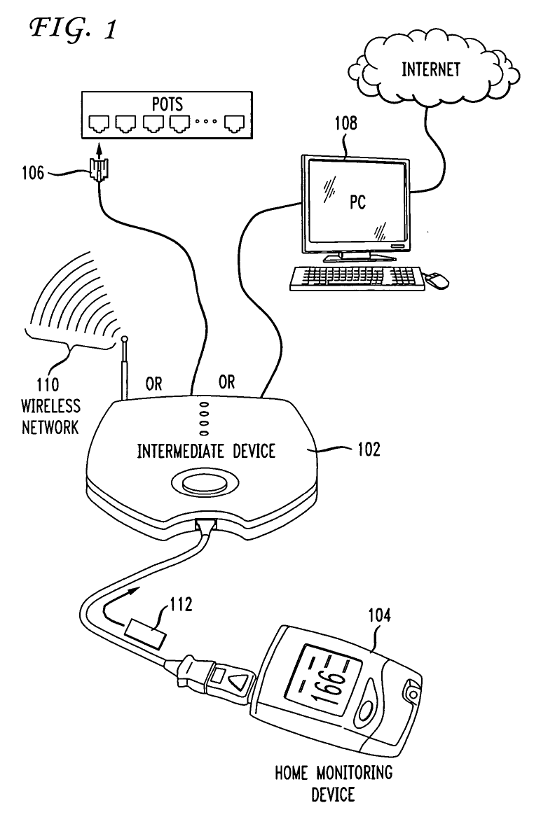

For purposes of illustrating the present, an intermediate device and home monitoring device are shown in FIG. 1. An intermediate biometric transmission device 102 (“intermediate device”) can be used as a single interface to connect to numerous types of home monitoring devices, one of which is shown in FIG. 1 as device 104. This may be useful at homes where there are more than one device being used or at a clinic where there are numerous types of devices (one for asthma, diabetes, blood pressure, etc.) or where the same type of device is being used for multiple patients.

It is also useful if only one type of device is used most or all of the time in that it facilitates data transmission. Once home monitoring device 104 is attached, intermediate device 102 can be attached to a phone outlet 106, to a computer 108 (via a wired connection or wireless), or be connected to a cellular phone or other mobile device 110. Biometric data 112 from the home device are then transmitted to the intermediate device. The intermediate device does not store the biometric data but buffers it and transmits the data to a central repository where the data are integrated with other biometric and a wide range of health-related data in a personal health record. It is also archived in its original, raw format, that is, the format specific to the home monitoring device as described in further detail below. Processes and systems for data transmission using this model are described in pending application Ser. No. 10/417,794, titled “Method and System for Communication and Collaboration Between a Patient and Healthcare Professional” which is incorporated herein for all purposes. An example of such a data transmission process and system is MediCompassConnect operated by iMetrikus, Inc. of Carlsbad, Calif.

The present invention describes methods and systems that ensure that biometric data readings 112 taken at home monitoring device 104 are transmitted with bit-by-bit accuracy via intermediate device 102 to a central repository. The standard of accuracy achieved in the biometric data transmission and verification techniques of the present invention meets certain United States Food and Drug Administration (FDA) requirements, such as Level 2 standards as provided in Title 21 of the Code of Federal Regulations (CFR), Part 11.

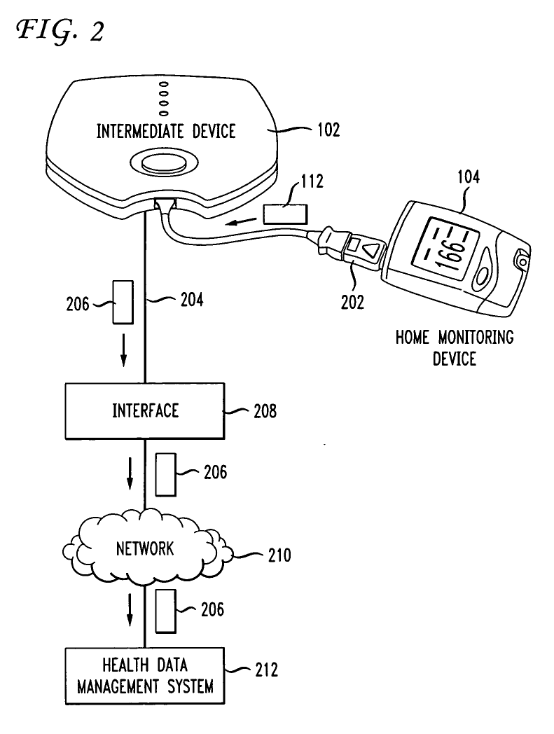

To describe in detail the methods and systems of the present invention, it is useful to further illustrate what was described above and disclosed in detail in the referenced pending patent applications. FIG. 2 is a network diagram showing the basic components and flow of data of the present invention. As first shown in FIG. 1, biometric home monitoring device 104 is connected to an intermediate data transmission device 102 using a communication protocol and interface suitable to home monitoring device 104. After a reading is taken with device 104, original biometric data 112 are transferred to the intermediate device via first transmission link 202. In a preferred embodiment, intermediate device 102 is not intended to be used as a data storage device. It has a small buffer in the range of 5 kB. A second data transmission link 204 is used to transmit encapsulated biometric data 206 from intermediate device 102 to an interface 208 for data transmission network 210, such as POTS, the Internet, a cellular phone network, satellite connection, and so on. Encapsulated biometric data 206 are received at a health data management system 212. At system 212 data 206 are integrated with a patient's health data, for example, in a personal health record as described in the referenced patent applications (not shown in FIG. 2). A portion of encapsulated biometric data packet 206, specifically, original biometric data 112, is stored in its original format in system 212.

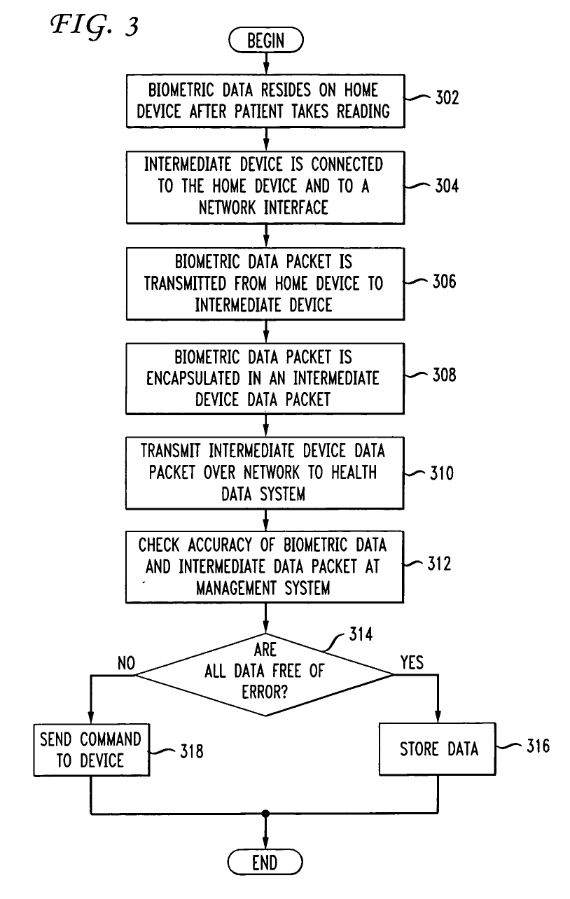

FIG. 3 is an overview flow diagram of a process of biometric data transmission in accordance with one embodiment of the present invention. At step 302 a patient has already taken a biometric reading using a home monitoring device and the data are presently residing on the device in a proprietary format. At step 304 an intermediate biometric data transmission device is connected to the home device and to a network (e.g., Internet via a PC or into a telephone outlet) as chosen by the patient or owner of the intermediate device. At step 306 biometric data are transmitted in the form of a data packet from the home device to the intermediate device and buffered in the intermediate device. Biometric data from home devices are typically in ASCII or binary format, have checksums, and other typical data packet characteristics. At step 308 the data packet is encapsulated into a second format specific to the intermediate device using algorithms on the device. At step 310 the encapsulated data packet is transmitted over a network and received at a health data management system.

At the management system, at step 312 the accuracy of the biometric data packet and the intermediate device data packet are checked using checksums, CRCs, and other methods known in the art. At step 314 the system determines if the data in the packets are accurate. If all the data are accurate, the biometric data in its raw format and in a format proprietary to the management system are stored in the management system at step 316. If an error or discrepancy is found, the data are not stored and the system sends commands to the intermediate device to be relayed to the biometric device and notifies the appropriate parties at step 318. In some cases the biometric device receives commands to re-send the reading.

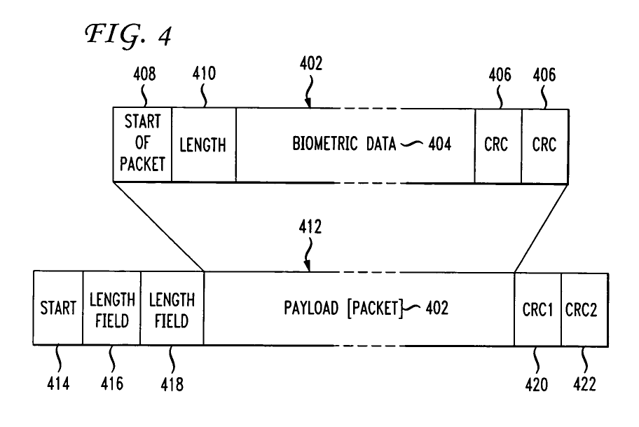

FIG. 4 is a diagram showing a sample of a biometric data packet and a sample of an intermediate device data packet in accordance with one embodiment of the present invention. Packet 402 is an original biometric data packet. Its format depends on the type of device however there are some characteristics they all share. As mentioned earlier, biometric data 404, the actual reading from the device, are usually in ASCII or binary format. For example, with one manufacturer's device, the data are in ASCII and are transmitted to a single packet in 12-byte increments. Most data have one or more checksum fields 406 or other data used to check the accuracy of the data after transmission over a communication means. Fields 406 (each CRC may be one byte) are used in a validation process described below. Packet 404 may also contain various other fields common to data packets being transmitted over a network such as field 408 and 410. Typically, a single data packet carries a portion (e.g., 12 bytes) of a biometric reading.

An encapsulated data packet or intermediate device data packet 412 consists of field 414 indicating the start of a new packet and fields 416 and 418 providing data on the length of the packet. CRC fields 420 and 422 are for checking the accuracy of the data after transmission. Thus, in a preferred embodiment of the present invention, data packet 402 is encapsulated within another data packet 412. Outer data packet 412 is transmitted over network 210. Thus, to ensure complete data accuracy at destination 212, the CRCs 406, 420, and 422 of the inner and outer data packets are all checked.

In a preferred embodiment, data validation and accuracy checks are performed entirely at health data management system 212 rather than at the patient side where biometric meter 104 and intermediate data transmission device 102 are used. Thus, in a preferred embodiment there are no CRC computations/checksum comparisons at the intermediate data device when it receives a data packet from the home monitoring device.

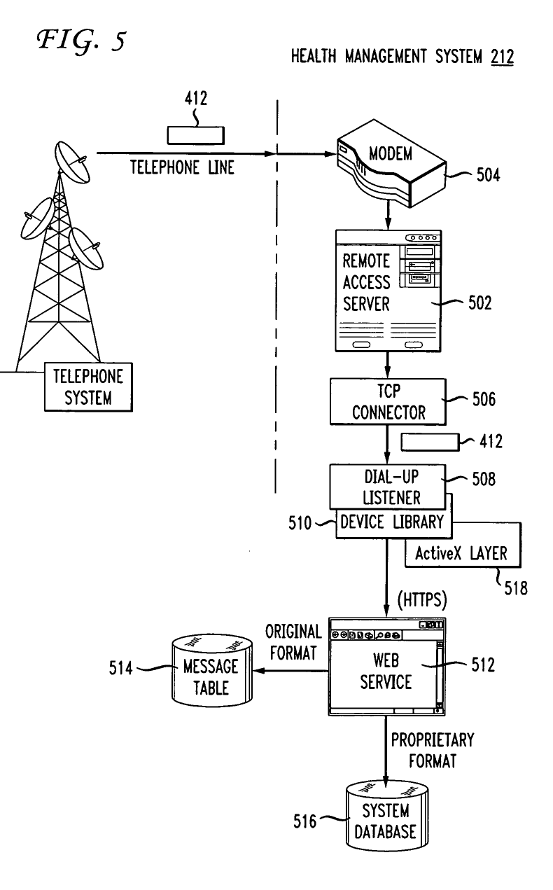

Intermediate device data packet can be transmitted to the health data management system via various modes as shown in FIG. 1. In one embodiment, data packet 412 is transmitted over POTS. In this embodiment, intermediate device 102 is plugged into a telephone outlet. FIG. 5 is a block diagram showing components of a health data management system in accordance with a described embodiment of the present invention. When intermediate device data packet 412 is received via POTS on a telephone line at data management system 212, the packet is de-modulated by a modem 504 and is input to a remote access server 502. Packet 412 is sent via a TCP connection 506 to a dial-up listener 508 (a TCP listener component). Listener 508 receives intermediate device data packet 412. In a preferred embodiment, dial-up listener 508 has a device library 510 which has logic and other data for enabling communication between various home devices and intermediate device 102 and management system 212. As described in the referenced pending patent applications, each home monitoring device that can be used with intermediate data transmitting device 102 of the present invention must have an entry describing its structure, proprietary data format, data on parsing the raw biometric data, CRC algorithms, etc. stored in device library 510.

After an initial series of exchanges between dial-up listener 508 and home device 104 (via intermediate device 102) to establish an operable communication link (e.g., having the correct baud rate), intermediate device data packet 412 containing actual biometric data is transmitted from the intermediate device to the dial-up listener. In a typical case, a single biometric reading upload (readings are usually between 4-20 bytes, however an upload can be several hundred or thousands of bytes) requires multiple original data packets each transmitting a portion of the biometric reading for transmission because the buffer size of the intermediate device in a preferred embodiment is comparatively small. All intermediate data packets, which are typically a maximum of 255 bytes, that have encapsulated original data packets from a single biometric reading are aggregated at the dial-up listener to re-construct the single reading. Generally, these data encapsulate a series of readings that make up an upload session and not necessarily a single reading. When intermediate data packets are received at dial-up listener 508, a CRC check is performed and the resulting checksums of the intermediate data packets are checked first to ensure that the data packet was transmitted without error over the network (assumed to be a noisy, error-introducing channel). Next, a CRC is calculated on the payload or original biometric data packet and the checksums are compared to ensure that the data packet containing the raw biometric data was transmitted accurately from meter 104 to intermediate device 102. Although this connection is short and relatively less noisy than the network, it is not assumed that the raw biometric data packets were transferred accurately. To ensure bit-by-bit accuracy of the data CRCs computations are performed and results are compared. Device-specific algorithms for these CRCs are retrieved from device library 510 on dial-up server 508. In another embodiment, device library 510 is stored on another component at management system 212. If there is a discrepancy in either of the data, a command is sent to intermediate device 102 to have data 112 re-sent. At this stage, the raw biometric data are ‘unpacked’ from the data packets and ready for further processing.

Information on home monitoring device 104, such as serial number, device type, and intermediate device serial number, and the like are transmitted via HTTPS from dial-up listener 508 to a Web service 512. The primary data item transmitted is a Bin64 encoded string representation of the raw biometric data. The raw data in its original format are stored in a health data management system message table 514. The raw data are also parsed using device-specific parsing mechanisms stored in the device library. Once the original raw data are parsed, the data are stored in a format proprietary to the health data management system 212 in a system database 516 in, for example, a personal health record.

This same process occurs for intermediate device data packets received at the health data management system via the Internet and via a cellular phone network, such as GPRS or Edge. When a data packet is received via the Internet at the management system, the CRCs of the intermediate device data packet and the CRCs of the original data packet are checked in an ActiveX layer 518 of the management system rather than at dial-up listener 508. The algorithms for the device-specific CRCs are retrieved from the device library as described above. Normally, an ActiveX layer resides on a PC or IP-enabled device and not on the back-end system as in the present invention because, as is well known in the art, an ActiveX layer is a client communication layer and offloads the communication to a client PC. Since a PC is able to do the processing and communication with the devices, ActiveX layer 518 is used to alleviate processing and execution load from the server. However, because of the two layers of data accuracy checks that are performed on the two data packets after transmission over a network, the ActiveX layer resides at the health data management system. If the intermediate data packets are received via a cellular phone network, they are received and processed at dial-up listener 508.

Although the foregoing invention has been described in some detail for purposes of clarity of understanding, it will be apparent that certain changes and modifications may be practiced within the scope of the appended claims. Furthermore, it should be noted that there are alternative ways of implementing both the methods and systems of the present invention. For example, the checksums of the original raw biometric data packet can be checked before the checksums of the intermediate data packet. In another example, checksums and CRC algorithms need not be used to check for data accuracy; other known data verifying techniques can be implemented. Accordingly, the present embodiments are to be considered as illustrative and not restrictive, and the invention is not to be limited to the details given herein, but may be modified within the scope and equivalents of the appended claims.

We claim:

1. A method of transmitting biometric data from a source to a destination, the method comprising:
storing the biometric data in a first data packet having a first checksum at the source, wherein the first data packet is created by a first device;
encapsulating the first data packet in a second data packet having a second checksum, wherein the second data packet is created by a second device;
transmitting the second data packet over a network from the source to the destination;
verifying the accuracy of the second data packet by checking the second checksum at the destination; and
verifying the accuracy of the first data packet by checking the first checksum at the destination and using a CRC algorithm specific to the first device that is stored at the destination.
